(19) United States
(12) Patent Application Publication
(10) Pub. No.: US 2017/0274599 A1
(43) Pub. Date: Sep. 28, 2017

(54) ADDITIVE MANUFACTURING APPARATUS AND ADDITIVE MANUFACTURING METHOD

(71) Applicant: Kabushiki Kaisha Toshiba, Minato-ku (JP)

(72) Inventors: Masaru KITAMURA, Yokohama (JP); Mikio ADACHI, Yokohama (JP); Tomomi INO, Yokohama (JP); Atsushi FUJIHARA, Chigasaki (JP)

(73) Assignee: Kabushiki Kaisha Toshiba, Minato-ku (JP)

(21) Appl. No.: 15/504,835

(22) PCT Filed: Mar. 17, 2015
(86) PCT No.: PCT/JP2015/057964

§ 371 Date: Feb. 17, 2017

(30) Foreign Application Priority Data
Sep. 19, 2014 (JP) 2014-191944

(51) Int. Cl. B29C 67/00; B33Y 30/00; B33Y 10/00; B33Y 50/02

(52) U.S. Cl. CPC B29C 67/0088; B33Y 50/02; B33Y 30/00; B33Y 10/00; B29C 67/0077

(57) ABSTRACT

According to one embodiment, an additive manufacturing apparatus includes a laminate formation unit, a binding formation unit, control unit and a detection unit. The laminate formation unit forms laminated layers of a powdered material. The binding formation unit binds at least a part of a layer to form a manufactured object. The control unit binds the layer by the binding formation unit on the basis of shape information of the manufactured object. The detection unit detects a shape of the part of the manufactured object. The control unit compares the shape of the manufactured object and the shape information.

### FIELD

Embodiments of the invention relate to an additive manufacturing apparatus and an additive manufacturing method.

### BACKGROUND

The additive manufacturing apparatus performs additive manufacturing by, for example, forming a layer of a powdered material and binding parts of materials in respective layers to each other. The additive manufacturing apparatus performs the additive manufacturing on the basis of three-dimensional data, for example, CAD data and data of a three-dimensionally scanned object.

### CITATION LIST

### Patent Literature

Patent Literature 1: Japanese Unexamined Patent Application Publication No. 2012-213972

### SUMMARY OF THE INVENTION

### Problem to be Solved by the Invention

The additive manufacturing apparatus performs the additive manufacturing on the basis of three-dimensional data, but a shape error may occur between the three-dimensional data and a manufactured object that is additively manufactured. For example, the shape error is determined after the additive manufacturing is completed.

An object of the present invention is to provide an additive manufacturing apparatus and an additive manufacturing method which are capable of performing additive manufacturing with relatively high accuracy.

### Means for Solving Problem

According to one embodiment, an additive manufacturing apparatus includes a laminate formation unit, a binding formation unit and a detection unit. The laminate formation unit is configured to form a plurality of laminated layers of a powdered material. The binding formation unit is configured to bind at least a part of a layer to form a part of a manufactured object, the layer forming a surface of the plurality of layers. The detection unit is configured to detect a shape of the part of the manufactured object, the part of the manufactured object formed in at least one layer including the layer forming the surface of the plurality of layers.

### BRIEF DESCRIPTION OF DRAWINGS

FIG. 1 is a cross-sectional view schematically illustrating a three-dimensional printer according to a first embodiment.

FIG. 2 is a perspective view illustrating a manufacturing tank and a measurement device according to the first embodiment.

FIG. 3 is a cross-sectional view illustrating the measurement device and the manufacturing tank in which a first detector detects a shape of a manufactured portion with an X-ray beam, according to the first embodiment.

FIG. 4 is a view illustrating an example of an image of a layer that is detected by the first detector according to the first embodiment.

FIG. 5 is a cross-sectional view illustrating the measurement device and the manufacturing tank in which a second detector detects the shape of the manufactured portion with an X-ray beam, according to the first embodiment.

FIG. 6 is a graph illustrating an example a detection result obtained by the second detector according to the first embodiment.

FIG. 7 is a block diagram functionally illustrating a configuration of a control unit according to the first embodiment.

FIG. 8 is a flowchart illustrating an example of a procedure of creating an error model DB according to the first embodiment.

FIG. 9 is a flowchart illustrating an example of a procedure of additive manufacturing a manufactured object according to the first embodiment.

FIG. 10 is a view schematically illustrating a method of calculating a surface shape model according to the first embodiment.

FIG. 11 is a perspective view schematically illustrating a detected shape obtained by a plurality of detection results according to the first embodiment.

FIG. 12 is a side view schematically illustrating an example of a prediction model, which is calculated by a prediction unit, of a manufactured object that is finally manufactured, according to the first embodiment.

FIG. 13 is a graph illustrating an example of a residual of the detected shape and the prediction model according to the first embodiment.

FIG. 14 is a graph illustrating an example of a T² statistic of the detected shape and the prediction model according to the first embodiment.

FIG. 15 is a graph illustrating an example of a Q statistic of the detected shape and the prediction model according to the first embodiment.

FIG. 16 is a cross-sectional view illustrating a measurement device and a manufacturing tank according to a second embodiment.

### DETAILED DESCRIPTION

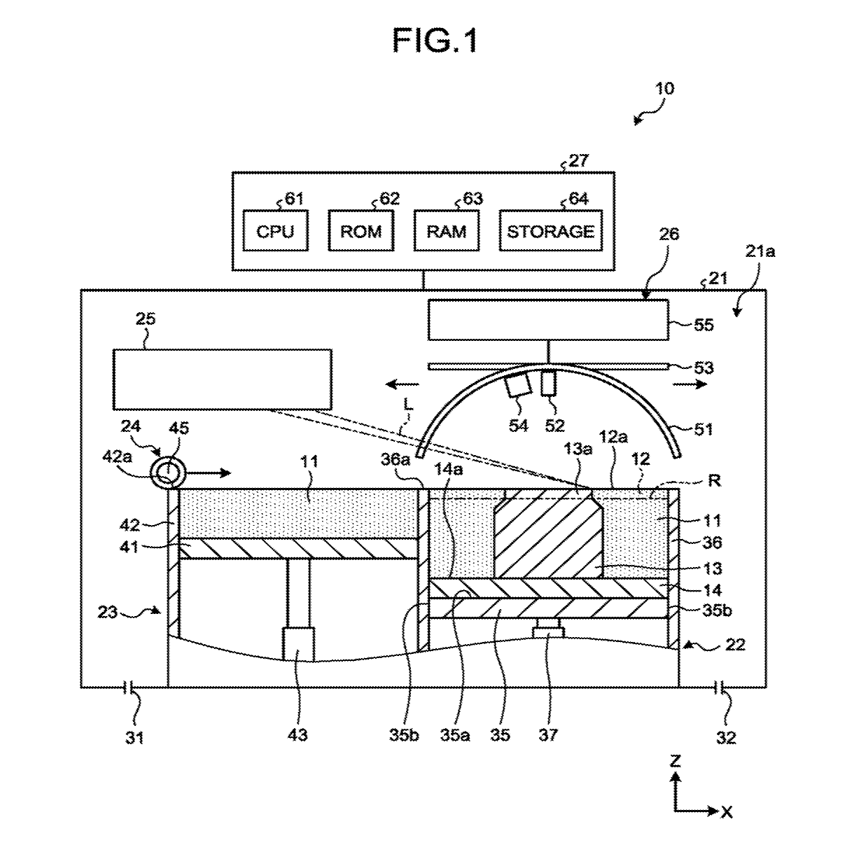

Hereinafter, description will be given of a first embodiment with reference to FIGS. 1 to 15. Note that, in this specification, basically, a vertically downward direction is defined as a downward direction, and a vertically upward direction is defined as an upward direction. In addition, a plurality of expressions may be used in description in combination with respect to a constituent element according to an embodiment or for explanation of the element. Another expression, which is not described for the constituent element and the explanation, may be employed. In addition, another expression may be employed for a constituent element and explanation thereof which are not described with a plurality of expressions.

FIG. 1 is a cross-sectional view schematically illustrating a three-dimensional printer 10 according to a first embodiment. The three-dimensional printer 10 is an example of an additive manufacturing apparatus. The three-dimensional printer 10 manufactures a three-dimensional manufactured object 13 by repeating formation of a layer 12 with a powdered material 11 and solidification of the material 11 that is used to form the layer 12. FIG. 1 illustrates one layer 12 that is divided by a two-dot chain line. For example, the manufactured object 13 is manufactured on a base plate 14 and is detached from the base plate 14 after completion of manufacturing.

As illustrated in FIG. 1, the three-dimensional printer 10 includes a treatment tank 21, a manufacturing tank 22, a material tank 23, a supply device 24, an optical device 25, a measurement device 26, and a control unit 27. The material tank 23 and the supply device 24 are examples of a laminate formation unit. The optical device 25 is an example of a binding formation unit and a processing unit. The measurement device 26 is an example of a detection unit.

For example, the treatment tank 21 may also be referred to as a housing. For example, the manufacturing tank 22 may also be referred to as a stage, a manufacturing region, or an application region. For example, the optical device 25 may also be referred to as a formation unit or a solidification unit. For example, the measurement device 26 may also be referred to as a measurement unit or a detection unit.

For example, the treatment tank 21 is formed a box shape that can be sealed. The treatment tank 21 includes a treatment chamber 21a. The manufacturing tank 22, the material tank 23, the supply device 24, the optical device 25, and the measurement device 26 are accommodated in the treatment chamber 21a. The manufacturing tank 22, the material tank 23, the supply device 24, the optical device 25, and the measurement device 26 may be located at the outside of the treatment chamber 21a.

A supply port 31 and a discharge port 32 are provided in the treatment chamber 21a of the treatment tank 21. For example, a gas supply device, which is provided on an outer side of the treatment tank 21, supplies an inert gas such as nitrogen and argon to the treatment chamber 21a through the supply port 31. For example, a gas discharge device, which is provided on an outer side of the treatment tank 21, discharges the inert gas in the treatment chamber 21a through the discharge port 32.

A plurality of layers 12 of the powdered material 11 are sequentially formed in the manufacturing tank 22. The plurality of layers 12 are laminated in the manufacturing tank 22. A manufactured portion 13a, which is a part of the manufactured object 13, is formed in each of the layers 12, and consequently the manufactured object 13 is manufactured in the manufacturing tank 22. The manufacturing tank 22 includes a loading stage 35, a peripheral wall 36, and an elevator 37.

As illustrated in the same drawing, in this specification, an X-axis, a Y-axis, and a Z-axis are defined. The X-axis, the Y-axis, and the Z-axis are perpendicular to each other. The X-axis lies along a width of the manufacturing tank 22. The Y-axis lies along a depth (length) of the manufacturing tank 22. The Z-axis lies along a height of the manufacturing tank 22.

The loading stage 35 is, for example, a square plate. The shape of the loading stage 35 is not limited thereto, and the loading stage 35 may be a member having another shape, such as other quadrangle (quadrilateral) such as a rectangle, a polygon, a circle, and a geometric shape. The loading stage 35 includes an upper face 35a, and four end faces 35b. The upper face 35a is an approximately flat quadrangular face. The end faces 35b are faces which are perpendicular to the upper face 35a.

The base plate 14 is loaded on the upper face 35a of the loading stage 35. For example, the base plate 14 is a plate that is made of the same material as that of the manufactured object 13. The base plate 14 is not limited thereto.

The base plate 14 includes an approximately flat manufacturing face 14a. The manufacturing face 14a can form a supply region R to which the material 11 is supplied, and on which the layer 12 of the material 11 is formed. Furthermore, the supply region R can be formed, for example, by the upper face 35a of the loading stage 35 without limitation to the manufacturing face 14a of the base plate 14. In addition, when the layer 12 of the material 11 is formed on the supply region R, the layer 12 forms the subsequent supply region R. In this manner, the supply region R is sequentially formed over the loading stage 35 and the base plate 14.

The peripheral wall 36 is formed in a quadrangular tubular shape that extends in a direction along the Z-axis and surrounds the loading stage 35. The four end faces 35b of the loading stage 35 come into contact with an inner face of the peripheral wall 36. The peripheral wall 36 includes an upper end 36a that is formed in a quadrangular frame shape, and is opened.

For example, the elevator 37 is a hydraulic elevator. The elevator 37 can move the loading stage 35 on an inner side of the peripheral wall 36 in a direction along the Z-axis. In a case where the loading stage 35 moves the most upward side, the upper face 35a of the loading stage 35 and the upper end 36a of the peripheral wall 36 are approximately flush with each other.

The supply region R is disposed on a downward side spaced away from the upper end 36a of the peripheral wall 36, for example, by 50 μm. When the layer 12 of the material 11 is formed on the supply region R, and the layer 12 forms the subsequent supply region R, the elevator 37 lowers the loading stage 35 by 50 μm. According to this, a distance between the supply region R and the upper end 36a of the peripheral wall 36 is maintained to be 50 μm. Note that the distance between the supply region R and the upper end 36a of the peripheral wall 36 may be changed in an arbitrary manner without limitation to the distance.

The material tank 23 is disposed adjacent to the manufacturing tank 22. The material tank 23 accommodates the material 11. The amount of the material 11 that can be accommodated in the material tank 23 is approximately the same as or greater than the amount of the material 11 that can be supplied to the manufacturing tank 22. The material tank 23 includes a support stage 41, a peripheral wall 42, and an elevator 43.

For example, the support stage 41 is a square plate. The shape and size of the support stage 41 is approximately the same as the shape and size of the loading stage 35 of the manufacturing tank 22. Note that the shape and size of the support stage 41 are not limited thereto. The support stage 41 supports the material 11 that is accommodated in the material tank 23.

The peripheral wall 42 is formed in a quadrangular tubular shape that extends in a direction along the Z-axis and surrounds the support stage 41. The peripheral wall 42 of the material tank 23 is formed integrally with the peripheral wall 36 of the manufacturing tank 22. The peripheral wall 42 includes an upper end 42a that is formed in a quadrangular frame shape, surrounds the support stage 41, and is opened. The upper end 42a of the support stage 42 continues to the upper end 36a of the peripheral wall 36 of the manufacturing tank 22.

For example, the elevator 43 is a hydraulic elevator. The elevator 43 can move the support stage 41 on an inner side of the peripheral wall 42 in a direction along the Z-axis. When the elevator 43 lifts the support stage 41, a part of the material 11 that is supported by the support stage 41 is pushed up to a more upward side in comparison to the upper end 42a of the peripheral wall 42.

The supply device 24 includes a roller 45. The roller 45 is disposed over the material tank 23, and extends in a direction along the Y-axis. A length of the roller 45 in the direction along the Y-axis is approximately the same as or longer than a length of the loading stage 35 in a direction along the Y-axis. The roller 45 can move from an upper side of the material tank 23 to an upper side of the manufacturing tank 22 along the X-axis.

When a part of the material 11 in the material tank 23 is pushed-up to a more upper side in comparison to the upper end 42a of the peripheral wall 42, the roller 45 presses the material 11 toward the manufacturing tank 22. According to this, the roller 45 supplies the material 11 in the material tank 23 to the supply region R in the manufacturing tank 22 to form the layer 12 of the material 11 on the supply region R.

The roller 45 smoothes the surface 12a of the layer 12 while supplying the material 11 to the supply region R. According to this, when the layer 12 is formed, the surface 12a of the layer 12 becomes approximately flat. The surface 12a of layer 12 is approximately flush with the upper and 36a of the peripheral wall 36 of the manufacturing tank 22. Accordingly, the thickness of one layer of a plurality of the layers 12 becomes 50 μm. The thickness of the one layer 12 is not limited thereto.

The supply device 24 may form the layer 12 of the material 11 on the supply region R by other devices without limitation to the roller 45. For example, in the supply device 24, a squeezing blade may press the material 11 instead of the roller 45 to smooth the surface 12a of the layer 12. In addition, for example, the supply device 24 may form the layer 12 of the material 11 by a head that ejects the material 11 or a nozzle that sprays the material 11.

The optical device 25 includes various components such as a light source that is provided with an oscillation element and emits laser light L, a conversion lens that converts the laser light L into parallel light, a convergence lens that converges the laser light L, and a galvano mirror that moves an irradiation position with the laser light L. FIG. 1 illustrates the laser light L by a two-dot chain line. The laser light L is an example of an energy ray, and can melt or sinter the material 11. Note that the energy ray may melt or sinter the material 11 similar to the laser light L, and may be, for example, an electron beam, an electronic wave in a range from a micro wave to an ultraviolet ray, and the like. The optical device 25 can change a power density of the laser light L.

The optical device 25 is located on a more upward side in comparison to the manufacturing tank 22. The optical device 25 may be disposed at other locations. The optical device 25 converts the laser light L emitted from the light source into parallel light by the conversion lens. The optical device 25 reflects the laser light L on the galvano mirror of which an inclination angle can be changed, and makes the laser light L to be converged by the convergence lens, thereby irradiating a desired position on the surface 12a of the layer 12 with the laser light L.

The optical device 25 melts or binds the material 11 of the layer 12 by irradiating the layer 12 with the laser light L. According to this, the optical device 25 binds portions, which form the surface 12a of the layer 12 and are irradiated with the laser light L, of the layer 12, thereby forming the manufactured portion 13a that is a part of the manufactured object 13.

The three-dimensional printer 10 may form the manufactured portion 13a by binding the layer 12 with other devices without limitation to the optical device 25. For example, the three-dimensional printer 10 may apply a coagulating agent such as an adhesive to the layer 12, and may bind a portion, to which the coagulating agent is applied, of the layer 12.

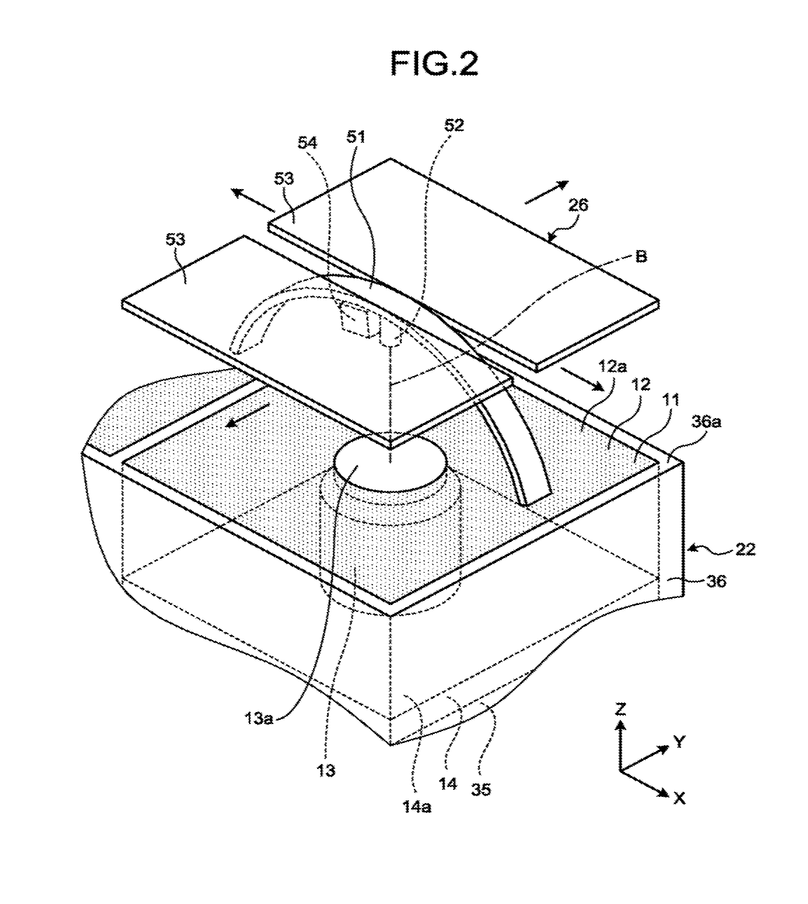

FIG. 2 is a perspective view illustrating the manufacturing tank 22 and the measurement device 26. The measurement device 26 measures a shape of the manufactured portion 13a which is formed in the layer 12. As illustrated in FIG. 1 and FIG. 2, the measurement device 26 includes a guide 51, an X-ray source 52, two first detectors 53, a second detector 54, and a movement unit 55 illustrated in FIG. 1.

As indicated by an arrow in FIG. 2, the movement unit 55 moves the guide 51, the X-ray source 52, the two first detectors 53, and the second detector 54 in an X-Y direction in combination with each other. Furthermore, the movement unit 55 may further move the guide 51, the X-ray source 52, the two first detectors 53, and the second detector 54 in the Z-direction. The X-ray source 52, the first detectors 53, and the second detector 54 scan, with X-rays, the entirety of at least one layer 12 including the layer 12 that forms the surface 12a while being moved by the movement unit 55.

The guide 51 is disposed on an upward side of the manufacturing tank 22. For example, the guide 51 is formed in a circular arc shape centering around one point on the surface 12a of the layer 12 that is formed in the manufacturing tank 22. Note that the shape of the guide 51 is not limited thereto.

The X-ray source 52 is attached to the guide 51 in a manner capable of being moved by the guide 51. The X-ray source 52 irradiates the surface 12a of the layer 12, which is formed in the manufacturing tank 22, with an X-ray beam B. The X-ray beam B is an example of an X-ray. The X-ray source 52 can change the energy and intensity of the X-ray beam B.

The X-ray source 52 can move along the guide 51, and can emit the X-ray beam B from a plurality of positions on the guide 51. That is, the X-ray source 52 can irradiate the surface 12a of the layer 12 with the X-ray beam B at a plurality of angles.

The first detectors 53 are, for example, semiconductor detectors capable of detecting an X-ray. The first detectors 53 are not limited thereto, and may be other kinds of detectors capable of detecting X-rays. Each of the first detectors 53 faces the surface 12a of the layer 12 that is formed in the manufacturing tank 22. The first detector 53 is disposed to be spaced away from the surface 12a of the layer 12 that is formed in the manufacturing tank 22.

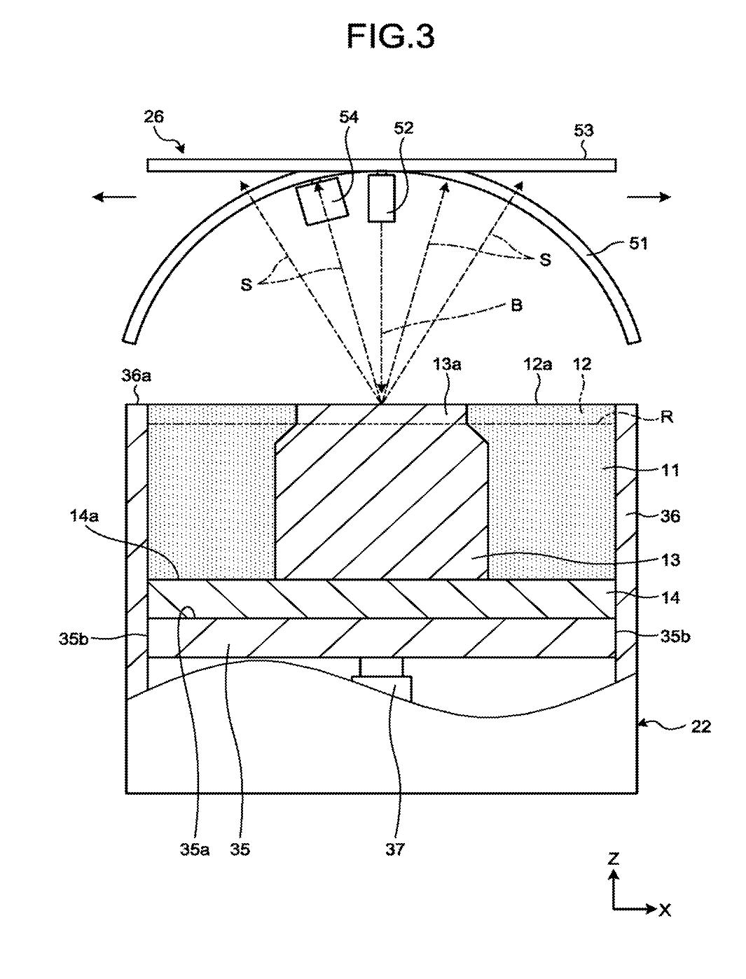

FIG. 3 is a cross-sectional view illustrating the measurement device 26 and the manufacturing tank 22 in which the first detector 53 detects the shape of the manufactured portion 13a with the X-ray beam B. As illustrated in FIG. 3, the X-ray source 52 irradiates the surface 12a of the layer 12 formed in the manufacturing tank 22 with the X-ray beam B at an approximately right angle. The X-ray beam B is scattered and diffracted into a plurality of X-rays S by the surface 12a of the layer 12 or at least one layer 12 including the layer 12 that forms the surface 12a.

The first detectors 53 detect the X-rays S which are scattered. The energy and intensity of an X-ray S that is scattered by a solid are different from the energy and intensity of an X-ray S that is scattered by a powder. Accordingly, the first detector 53 can detect a shape of the manufactured portion 13a, which is a solid formed in at least one layer 12 including the layer 12 that forms the surface 12a, by detecting the X-rays S which are scattered. The number of the layers 12, which are detected by the first detector 53, increases as the energy of the X-ray beam B that is emitted from the X-ray source 52 becomes stronger.

The first detectors 53 detect the shape of the manufactured portion 13a by detecting the X-rays S which are scattered from each irradiation point while being moved integrally with the X-ray source 52, which emits the X-ray beam B, in the X-Y direction by the movement unit 55. That is, the X-ray source 52 and the first detectors 53 are moved in the X-Y direction by the movement unit 55 while scanning the layer 12.

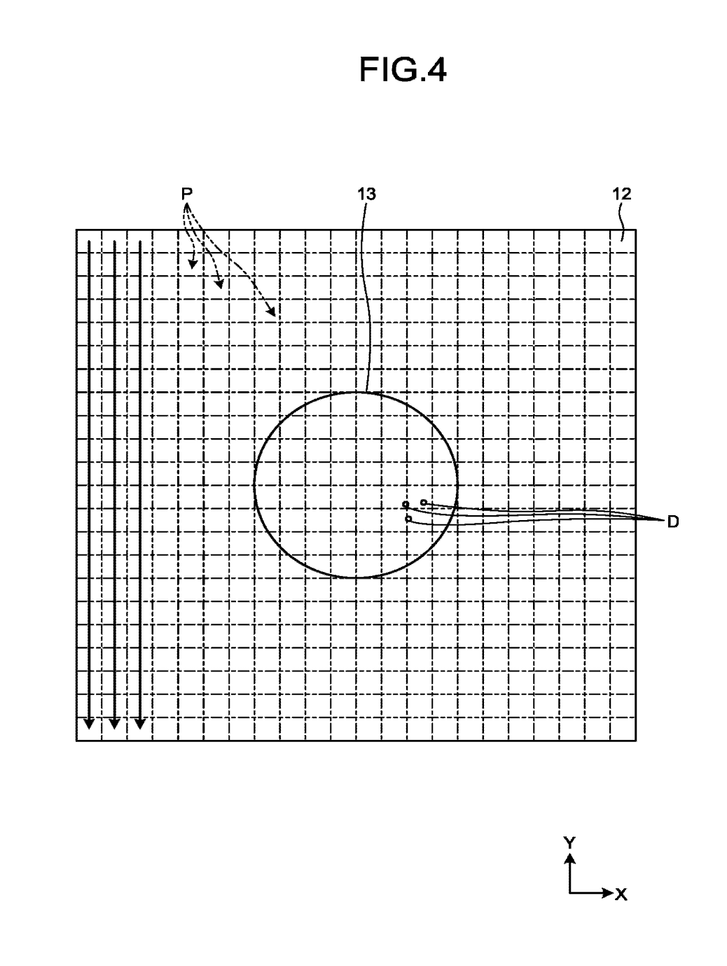

FIG. 4 is a view illustrating an example of an image of the layer 12 that is detected by the first detector 53. In addition, in FIG. 4, respective irradiation points P are schematically illustrated by being divided with a two-dot chain line. Note that, in FIG. 4, each of the irradiation points P is expressed in an exaggerated size for explanation. As illustrated in FIG. 4, the first detectors 53 sequentially irradiate the respectively irradiation points P with the X-ray beam B as indicated by an arrow, and detects the X-rays S which are scattered from the irradiation points P. The first detectors 53 scan the entirety of the surface of the layer 12 to detect the shape of the manufactured portion 13a, for example, as an image. The image is an image that is obtained by observing at least one layer 12 including the layer 12 which forms the surface 12a, from an immediately above side of the layer 12. As described above, the energy and intensity of the X-rays S, which are scattered, are different between a solid and a powder. Accordingly, in the layer 12, it is possible to identify a portion at which the manufactured portion 13a is formed and a portion at which the powdered material 11 remains. A detection result obtained by the first detector 53 is not limited thereto.

A defect D may occur in the manufactured portion 13a that is detected by the first detectors 53. The defect D is a hole or a cavity that is formed in the manufactured portion 13a. The defect D may be visually recognized with an eye from a surface of the manufactured portion 13a, or may be formed at the inside of the manufactured portion 13a.

The X-rays S are scattered not only the surface 12a of the layer 12 but also at the inside of at least one layer 12 including the layer 12 that forms the surface 12a. The first detectors 53 can detect the defect D, which occurs on the inner side of the manufactured portion 13a, by detecting the X-rays S which are scattered on the inner side of the layer 12. As the energy of the X-ray beam B emitted from the X-ray source 52 increases, the first detectors 53 can detect the defect D that is further spaced away from the surface 12a of the layer 12. For example, the first detectors 53 can detect the defect D having a width of several μm to several mm.

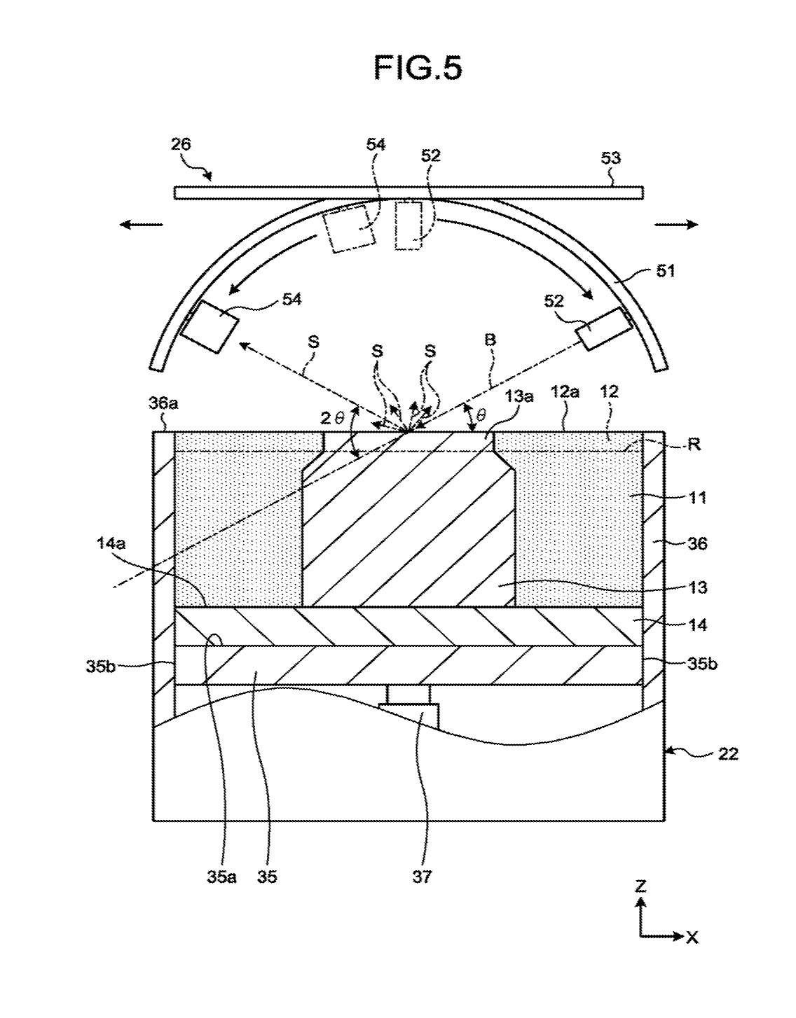

FIG. 5 is a cross-sectional view illustrating the measurement device 26 and the manufacturing tank 22 in which the second detector 54 detects the shape of the manufactured portion 13a with the X-ray beam B. The second detector 54 is a counter that can detect the intensity of the X-rays S which are diffracted. The second detector 54 may be other detectors capable of detecting the intensity of the X-rays S which are diffracted without limitation thereto.

The second detector 54 is attached to the guide 51 in a manner capable of being moved by the guide 51. The second detector 54 can move along the guide 51, and can be disposed at a plurality of positions on the guide 51. The second detector 54 moves along the guide 51 while facing one point on the surface 12a of the layer 12 which the X-ray source 52 faces. The second detector 54 is not limited thereto.

The X-ray source 52 emits the X-ray beam B to be incident to the surface 12a of the layer 12 formed in the manufacturing tank 22 at a predetermined angle θ in order for the X-rays S, which are diffracted at a point irradiated with the X-ray beam B, to be detected with the second detector 54. The diffracted X-rays S are X-rays S which satisfy Bragg's condition (mutually intensifying conditions: λ=2d sin θ, λ: wavelength, and d: interplanar distance) among X-rays S which are scattered at an irradiation point. The angle θ is greater than 0° and is less than 90°. Note that a more appropriate angle θ, at which the X-ray beam B is emitted from the X-ray source 52, varies depending on various conditions such as a component of the material 11.

The second detector 54 detects the X-rays S, which are diffracted by the layer 12, at the plurality of positions on the guide 51. The second detector 54 detects the intensity for each diffraction angle of the X-rays S which are diffracted.

The movement unit 55 moves the X-ray source 52 and the second detector 54 to cause the second detector 54 to detect the intensity of the X-rays S, which are diffracted, for each diffraction angle in respective coordinates on an X-Y plane of the layer 12.

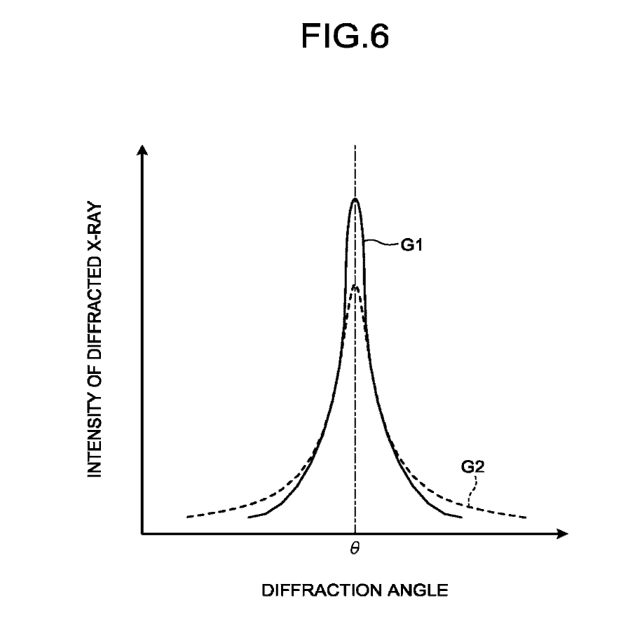

FIG. 6 is a graph illustrating an example of a detection result obtained by the second detector 54. The second detector 54 detects the shape of the manufactured portion 13a for each coordinate on the X-Y plane of the layer 12, for example, as a graph illustrated in FIG. 6. FIG. 6 illustrates a detection result G1 with a solid line in a case where a portion, which does not include the defect D, of the manufactured portion 13a is irradiated with the X-ray beam B, and illustrates a detection result G2 with a broken line in a case where a portion, which includes the defect D, of the manufactured portion 13a is irradiated with the X-ray beam B.

As illustrated in FIG. 6, the detection results G1 and G2 are distributed to be maximum values at an angle θ (Bragg's X-ray diffraction angle). However, in a case where the defect D is present, a deviation occurs in an angle at which the X-rays S are diffracted in the defect D. Accordingly, the detection result G2 shows a distribution in which a slope is gentler and the intensity is smaller in comparison to the analysis result G1. In this manner, the portion, which includes the defect D, of the manufactured portion 13a and other portions of the manufactured portion 13a are different in an intensity distribution for each diffraction angle of the X-rays S which are diffracted.

The second detector 54 can detect the shape of the manufactured portion 13a by using the intensity detection result for each diffraction angle of the X-rays S which are diffracted. That is, the second detector 54 detects the manufactured portion 13a, which is formed in at least one layer 12 including the layer 12 that forms the surface 12a of the plurality of layers 12, on the basis of an angle between the surface 12a of the plurality of layers 12, and the X-rays S which are diffracted by at least one layer 12 including the layer 12 that forms the surface 12a of the plurality of layers 12. In addition, the second detector 54 can detect a position, at which the defect D occurs, of the manufactured portion 13a by obtaining the detection result at the respective coordinates on the X-Y plane of the layer 12. For example, the second detector 54 can detect the defect D having a size of several μm to several mm.

As described above, the measurement device 26 detects the shape of the manufactured portion 13a, which is a part of the manufactured object 13 formed in at least one layer 12 including the layer 12 that forms the surface 12a of the plurality of layers 12, with the X-ray beam B. The measurement device 26 may irradiate a side face of the layer 12 with the X-ray beam B emitted in parallel to the surface 12a, and can detect the shape of the manufactured portion 13a with an X-ray S that is transmitted through the layer 12 without limitation to the above-described method. In addition, the measurement device 26 can detect the shape of the manufactured portion 13a by irradiating the layer 12 with an energy ray such as a γ-ray, a neutron ray, an electron ray, and an ion beam as an example without limitation to the X-ray beam B.

A control unit 27 illustrated in FIG. 1 is electrically connected to the manufacturing tank 22, the material tank 23, the supply device 24, the optical device 25, and the measurement device 26. For example, the control unit 27 includes various electronic components such as a CPU 61, a ROM 62, a RAM 63, and storage 64. The storage 64 is a device such as an HDD and an SSD which can store, change, and delete information.

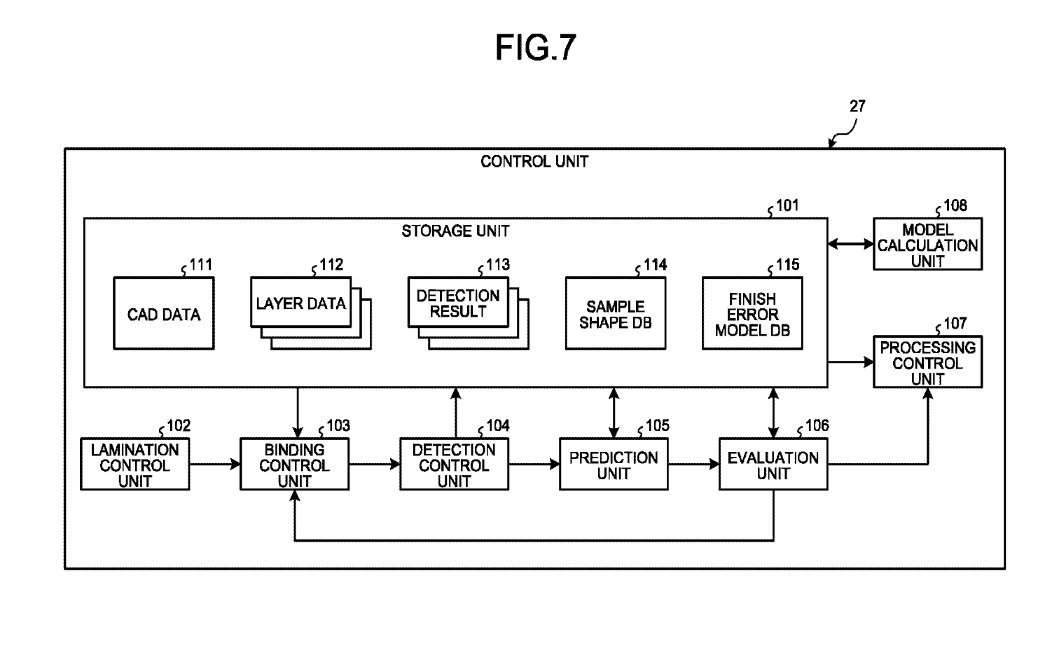

FIG. 7 is a block diagram functionally illustrating a configuration of the control unit 27. For example, in the control unit 27, the CPU 61 reads out a program that is stored in the ROM 62 or the storage 64 and executes the program, thereby realizing respective units illustrated in FIG. 7. As illustrated in FIG. 7, the control unit 27 includes a storage unit 101, a lamination control unit 102, a binding control unit 103, a detection control unit 104, a prediction unit 105, an evaluation unit 106, a processing control unit 107, and a model calculating unit 108.

The storage unit 101 stores various pieces of information including CAD data 111, a plurality of pieces of layer data 112, a plurality of detection results 113, a sample shape database (hereinafter, refer to as “sample shape DB”) 114, and a finish error model database (hereinafter, referred to as “finish error model DB”) 115. The storage unit 101 is provided in the RAM 63 or the storage 64. The CAD data 111 and the layer data 112 are examples of shape information of a manufactured object. The sample shape DB 114 is an example of shape information of a plurality of samples. The finish error model DB 115 is an example of error prediction information.

The lamination control unit 102 controls the manufacturing tank 22, the material tank 23, and the supply device 24 to form the layer 12 of the material 11 on the supply region R. The binding control unit 103 controls the optical device 25 to bind at least a part of the layer 12 of the material 11, thereby forming the manufactured portion 13a in the layer 12. The binding control unit 103 forms the manufactured portion 13a with the optical device 25 on the basis of the plurality of pieces of layer data 112 which are generated from the CAD data 111 of the manufactured object 13.

The detection control unit 104 controls the measurement device 26 to detect the shape of the manufactured portion 13a that is formed. The detection control unit 104 stores the detection results 113 of the shapes of the manufactured portions 13a of the plurality of layers 12 in the storage unit 101.

The prediction unit 105 predicts the shape of the manufactured object 13 that is finally manufactured on the basis of the detected shape of the manufactured portion 13a. The prediction unit 105 predicts the shape of the manufactured object 13 that is finally manufactured by using the finish error model DB 115. The finish error model DB 115 will be described later.

The evaluation unit 106 evaluates the detection result 113 of the shape of the manufactured portion 13a which is detected and the prediction result of the shape of the manufactured object 13 which is calculated by the prediction unit 105. For example, the processing control unit 107 controls the optical device 25 on the basis of the evaluation result of the evaluation unit 106 to process the manufactured portion 13a and the layer 12 that is formed.

The model calculating unit 108 calculates the finish error model DB 115. The model calculating unit 108 calculates the finish error model DB 115 before additive manufacturing of the manufactured object 13 by the three-dimensional printer 10.

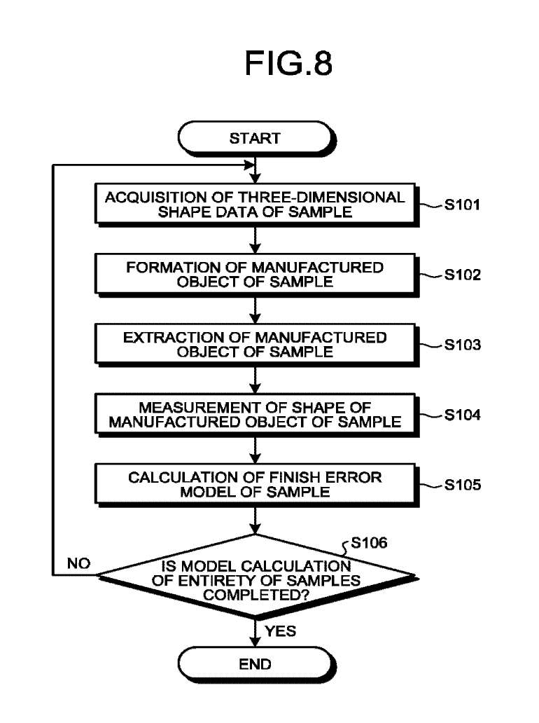

FIG. 8 is a flowchart illustrating an example of a procedure of creating the error model DB 115. Hereinafter, description will be given of an example of the procedure of creating the finish error model DB 115 by the three-dimensional printer 10.

For example, the finish error model DB 115 is residual information from three-dimensional shape data of a plurality of samples which are obtained in advance through additive manufacturing by the three-dimensional printer 10. That is, the three-dimensional printer 10 obtains the plurality of additive manufactured samples in advance, measures the shape of the additive manufactured samples, and creates the finish error model DB 115 from the three-dimensional shape data of the samples and the measurement result of the samples.

The three-dimensional printer 10 obtains the plurality of samples through, for example, additive manufacturing during a first operation, and creates the finish error model DB 115. Note that, there is no limitation thereto, and the three-dimensional printer 10 can create the finish error model DB 115, for example, during an operation after maintenance. In addition, in the three-dimensional printer 10, the finish error model DB 115 may be stored in the storage unit 101 in advance. The three-dimensional printer 10 obtains the plurality of samples through additive manufacturing at the first operation, and can correct the finish error model DB 115.

First, the binding control unit 103 acquires three-dimensional shape data of one sample from the sample shape DB 114 in the storage unit 101 (S101). The sample shape DB 114 includes three-dimensional shape data of samples having various shapes such as a rectangular parallelepiped, a circular column, a prismatic column, a cone, and a pyramid.

Next, the lamination control unit 102 causes the material tank 23 and the supply device 24 to form the layer 12 of the material 11. The binding control unit 103 causes the optical device 25 to form the manufactured portion 13a on the basis of the three-dimensional shape data of the sample. The lamination control unit 102 and the binding control unit 103 repeat the formation of the layer 12 and the formation of the manufactured portion 13a to form the manufactured object 13 of the sample (S102). The manufactured object 13 of the sample has a shape based on the three-dimensional shape data of the sample which is acquired by the binding control unit 103.

Next, for example, the lamination control unit 102 cause the manufactured object 13 of the sample to be extracted from the remaining powdered material 11 (S103). For example, the lamination control unit 102 causes the elevator 37 to lift the loading stage 35. According to this, the material 11 that covers the manufactured object 13 of the sample falls down, and thus the manufactured object 13 of the sample is extracted. A method of extracting the manufactured object 13 of the sample is not limited thereto. For example, an arm may extract the manufactured object 13 of the sample from the powdered material 11.

For example, the processing control unit 107 causes the optical device 25 to emit the laser light L to detach the extracted manufactured object 13 of the sample from the base plate 14 by using the laser light L. The manufactured object 13 of the sample may be detached from the base plate 14 by the other methods such as milling, for example, without limitation to the above-described method.

Next, the detection control unit 104 causes the measurement device 26 to measure the shape of the manufactured object 13 of the sample (S104). The detection control unit 104 can sequentially measure the shape of the manufactured portion 13a of the manufactured object 13 of the sample. In this case, the detection control unit 104 combines a plurality of the detection results 113 which are sequentially obtained, and acquires the shape of the manufactured object 13 of the sample.

Next, the model calculating unit 108 calculates a finish error model with respect to the additive manufactured sample, and records the finish error model in the finish error model DB 115 (S105). For example, the model calculating unit 108 compares the detection result of the shape of the manufactured object 13 of the sample, and the three-dimensional shape data of the sample with each other. According to this, the model calculating unit 108 calculates residual information from the three-dimensional shape data of the sample, and records the residual information in the finish error model DB 115 as a finish error model. In this manner, the finish error model DB 115 is calculated from the shape of the manufactured object 13 of the sample that is formed in advance with the optical device 25.

Next, the model calculating unit 108 determines whether or not the finish error model of the entirety of samples is calculated (S106). In a case where a sample of which the finish error model is not calculated remains (No in S106), the binding control unit 103 acquires the three-dimensional shape data of the subsequent sample from the sample shape DB 114 in the storage unit 101 (S101). In a case where the finish error model of the entirety of samples is calculated (Yes in S106), the creation of the finish error model DB 115 is terminated.

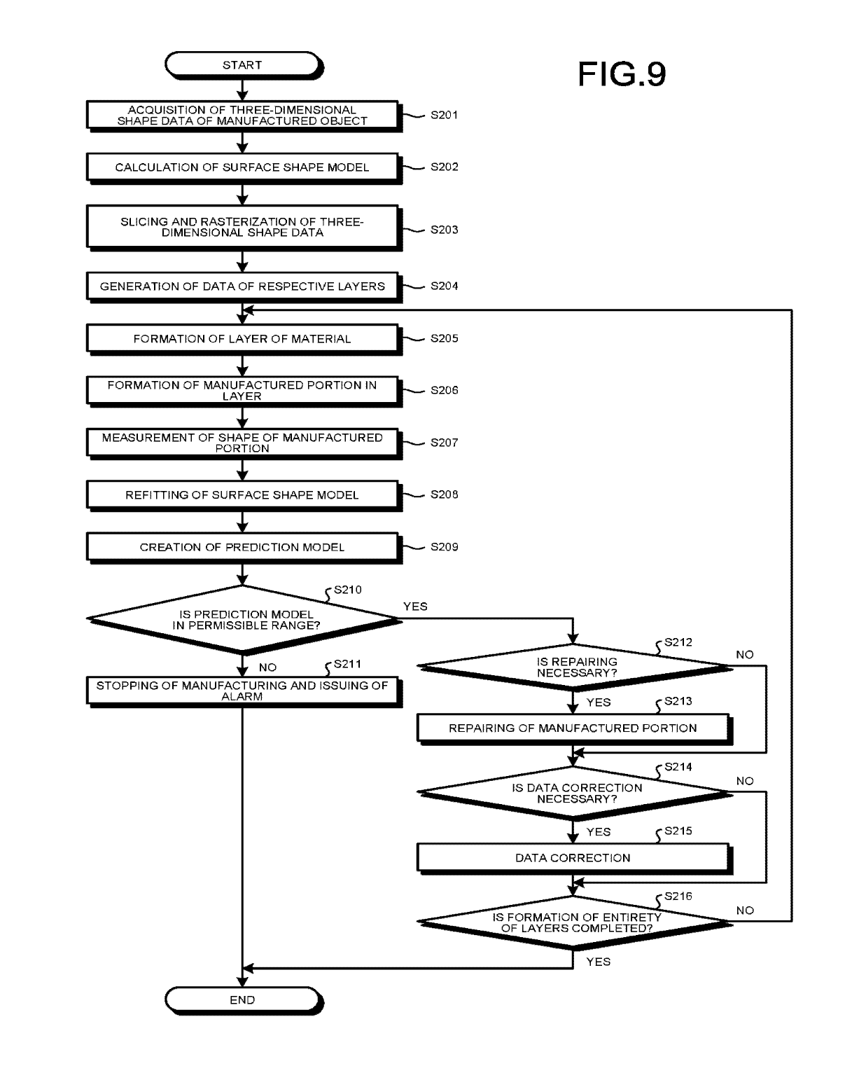

FIG. 9 is a flowchart illustrating an example of a procedure of obtaining the manufactured object 13 through additive manufacturing. Hereinafter, description will be given of an example of the procedure of obtaining the manufactured object 13 through additive manufacturing from the powdered material 11 by the three-dimensional printer 10. The additive manufacturing method of the manufactured object 13, which is executed by the three-dimensional printer 10, is not limited to the following description.

First, the CAD data 111 of the manufactured object 13 is input to the control unit 27 of the three-dimensional printer 10, for example, from an external pc (S201). The input CAD data 111 is stored in the storage unit 101. The CAD data 111 includes the three-dimensional shape data of the manufactured object 13 and dimensional tolerance data of the manufactured object 13.

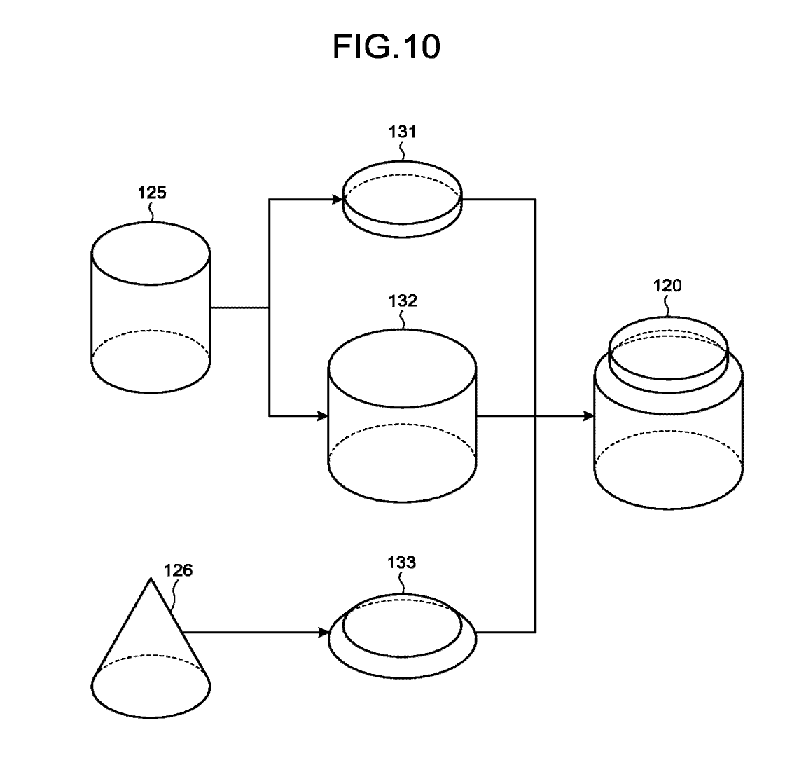

FIG. 10 is a view schematically illustrating a method of calculating a surface shape model 120. Next, the prediction unit 105 calculates the surface shape model 120 from the CAD data 111 (S202). The surface shape model 120 is information that is used by the prediction unit 105 to predict the shape of the manufactured object 13 that is finally manufactured. The surface shape model 120, which is calculated for the first time, has a shape that is approximate to a three-dimensional shape of the CAD data 111 of the manufactured object 13.

First, the prediction unit 105 acquires three-dimensional shape data of various samples from the sample shape DB 114 in the storage unit 101. For example, the prediction unit 105 acquires data of a circular column shape 125 and data of a conical shape 126 from the sample shape DB 114. The sample shape DB 114 includes data of various three-dimensional shapes without limitation to the circular column shape 125 and the conical shape 126. A surface of the circular column shape 125 is expressed, for example, by Expression f(x, y, z). A surface of the conical shape 126 is expressed, for example, by Expression g(x, y, z).

The prediction unit 105 calculates data of a first surface shape 131 and data of a second surface shape 132 from the acquired data of the circular column shape 125. The prediction unit 105 performs processing such as reduction, enlargement, and cutting out with respect to the data of the circular column shape 125 to calculate the data of the first surface shape 131 and the data of the second surface shape 132.

For example, the first surface shape 131 is expressed by Expression A1·f(x, y, z) obtained by multiplying Expression f(x, y, z) of the circular column shape 125 by a coefficient A1. For example, the second surface shape 132 is expressed by Expression B1·f(x, y, z) obtained by multiplying Expression f(x, y, z) of the circular column shape 125 by a coefficient B1. The first surface shape 131 and the second surface shape 132 are not limited thereto.

Similarly, the prediction unit 105 calculates data of a third surface shape 133 from the acquired data of the conical shape 126. The prediction unit 105 performs processing such as reduction, enlargement, and cutting out with respect to the data of the conical shape 126 to calculate the data of the third surface shape 133.

For example, the third surface shape 133 is expressed by Expression C1·g(x, y, z) obtained by multiplying Expression g(x, y, z) of the conical shape 126 by a coefficient C1. The third surface shape 133 is not limited thereto.

The prediction unit 105 calculates the surface shape model 120 in combination of the first surface shape 131, the second surface shape 132, and the third surface shape 133. The surface shape of the surface shape model 120 is expressed, for example, by Expression Y(x, y, z)=A1·f(x, y, z)+B1·f(x, y, z)+C1·g(x, y, z). The surface shape model 120 is not limited thereto.

As described above, the prediction unit 105 calculates the surface shape model 120 by connecting surface shapes of various samples to each other. The prediction unit 105 stores the surface shape model 120 in the storage unit 101.

Next, as illustrated in FIG. 9, the binding control unit 103 divides (slices) the three-dimensional shape of the CAD data 111 into a plurality of layers. The binding control unit 103 converts (rasterizes, pixelates) the sliced three-dimensional shape, for example, into a collection of a plurality of points or rectangular parallelepipeds. In this manner, the binding control unit 103 generates data of a plurality of layers having a two-dimensional shape from the CAD data 111 of the manufactured object 13 which is acquired (S203). The binding control unit 103 records the generated data in the storage unit 101.

Next, the binding control unit 103 generates the layer data 112 that is data of the plurality of layers 12 from the data of the plurality of layers having a two-dimensional shape (S204). As is the case with the data of the plurality of layers having a two-dimensional shape, the layer data 112 is a collection of a plurality of pixels. The layer data 112 includes information of a bound portion of the material 11, and information of a portion of the material 11 which remains in a powdered shape as is. The binding control unit 103 records the generated layer data 112 in the storage unit 101.

Next, the lamination control unit 102 controls the material tank 23 and the supply device 24 to form the layer 12 of the material 11 on the supply region R in the manufacturing tank 22 (S205). In a case where the base plate 14 forms the supply region R, the layer 12 is formed on the supply region R of the base plate 14. In a case where the layer 12 forms the supply region R, the layer 12, which is newly formed by the lamination control unit 102, is laminated on the layer 12 that forms the supply region R.

Next, the binding control unit 103 controls the optical device 25 to bind at least a part of the layer 12 of the material 11, thereby forming the manufactured portion 13a (S206). In addition, for example, a surface of the manufactured portion 13a may be shaped through milling.

The binding control unit 103 causes the optical device 25 to form the manufactured portion 13a on the basis of the layer data 112. However, a shape error may occur between the shape of the manufactured portion 13a in the layer data 112, and the manufactured portion 13a that is formed by the optical device 25.

Next, the detection control unit 104 controls the measurement device 26 to detect the shape of the manufactured portion 13a that is formed on a layer 12 that forms the surface 12a of the plurality of layers 12 (S207). The detection control unit 104 acquires the detection result 113 of the manufactured portion 13a by the first detectors 53 and the second detector 54 of the measurement device 26. The detection control unit 104 stores the detection result 113 in the storage unit 101.

Furthermore, the detection control unit 104 can detect the shape of the manufactured portion 13a that is formed with the plurality of layers 12 including the layer 12 that forms the surface 12a. In this case, for example, the detection control unit 104 determines whether or not the manufactured portion 13a is formed with a predetermined number of layers 12. In a case where it is determined that the manufactured portion 13a is formed with the predetermined number of layers 12, the detection control unit 104 allows the measurement device 26 to detect the shape of the manufactured portion 13a that is formed with the plurality of layers 12.

Next, the prediction unit 105 performs refitting of the surface shape model 120 (S208). The prediction unit 105 acquires the detection result 113 from the storage unit 101, and corrects the surface shape model 120 on the basis of the detection result 113.

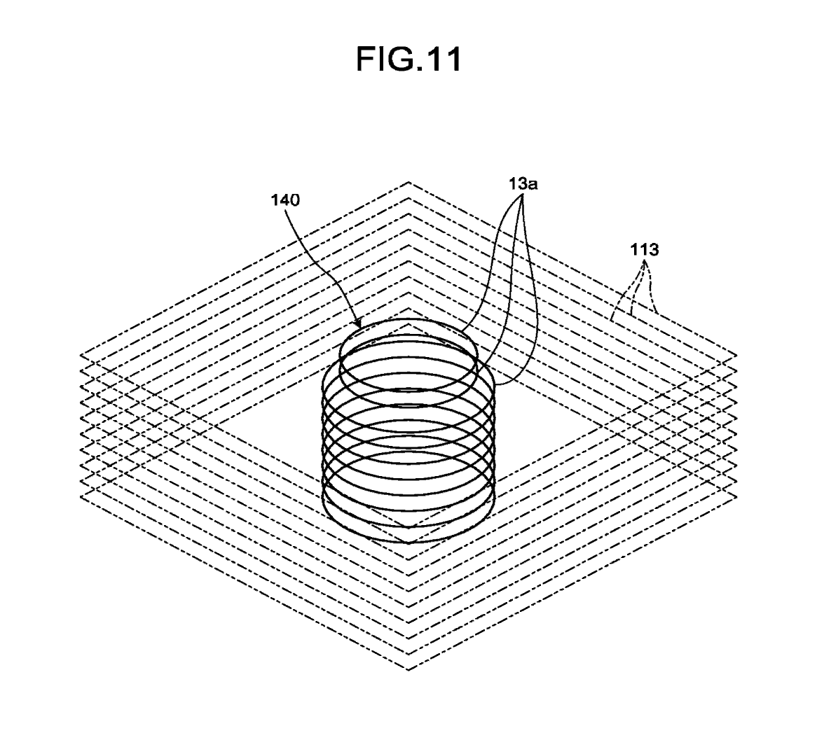

FIG. 11 is a perspective view schematically illustrating a detected shape 140 that is obtained by a plurality of the detection results 113. As illustrated in FIG. 11, the prediction unit 105 superimposes the plurality of detection results 113 for each thickness of the layer 12. Portions, which represent the manufactured portion 13a, of the detection results 113 which are superimposed forms the detected shape 140 that is approximate to the manufactured portion 13a that is already manufactured. That is, the prediction unit 105 calculates the detected shape 140, which is a three-dimensional shape, from the plurality of detection results 113 representing a two-dimensional shape.

The prediction unit 105 corrects the surface shape model 120, which is stored in the storage unit 101, in accordance with the detected shape 140 that is calculated. For example, the prediction unit 105 changes the respective coefficients in Expressions representing the surface shape model 120. A surface shape of the corrected surface shape model 120 is expressed, for example, by Expression Y(x, y, z)=A2·f(x, y, z)+B2·f(x, y, z)+C2·g(x, y, z). The surface shape model 120 is not limited thereto.

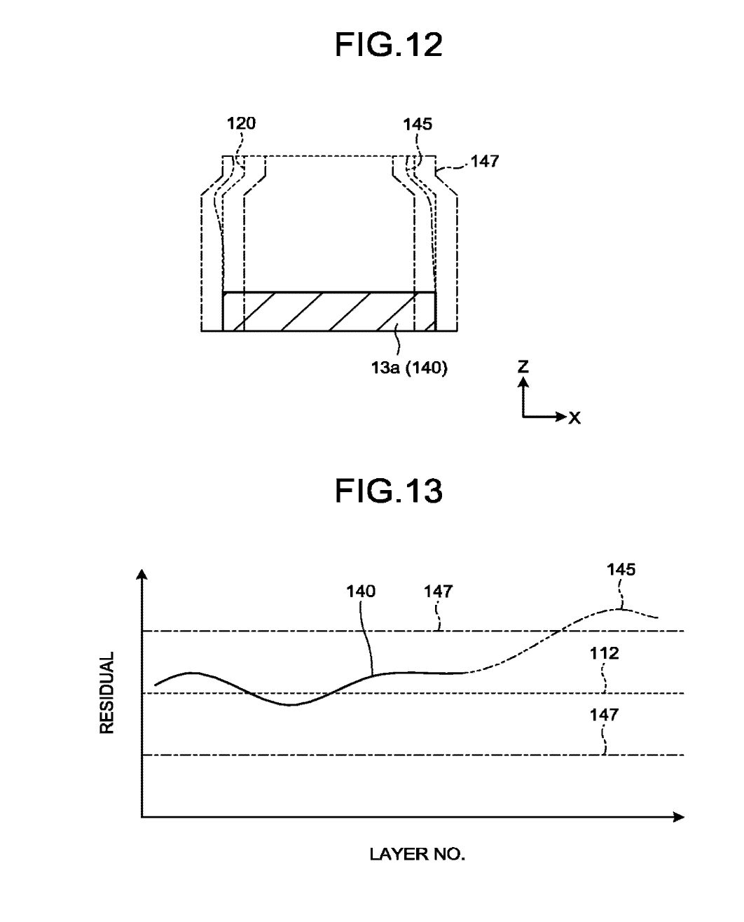

Next, the prediction unit 105 predicts the shape of the manufactured object 13 that is finally manufactured (S209). FIG. 12 is a side view schematically illustrating an example of a calculated prediction model 145, which is calculated by the prediction unit 105, of the manufactured object 13 that is finally manufactured. The prediction model 145 is an example of a predicted shape of a manufactured object that is formed. In FIG. 12, the surface shape model 120 is indicated by a broken line, and the prediction model 145 is indicated by a two-dot chain line.

The prediction unit 105 calculates the prediction model 145 from the surface shape model 120 that is corrected on the basis of the detected shape 140. That is, the prediction unit 105 calculates the prediction model 145 on the basis of the shape of the manufactured portion 13a which is detected by the measurement device 26.

As described above, the surface shape model 120 is formed by the first surface shape 131, the second surface shape 132, and the third surface shape 133 which are formed from the circular column shape 125 and the conical shape 126 which are samples. The prediction unit 105 acquires a finish error model corresponding to the circular column shape 125 and the conical shape 126, which are samples used in the surface shape model 120, from the finish error model DB 115.

The prediction unit 105 calculates a finish error model relating to the first surface shape 131, the second surface shape 132, and the third surface shape 133 from a finish error model corresponding to the circular column shape 125 and the conical shape 126. The prediction unit 105 calculates the prediction model 145 in combination of the finish error models relating to the first to third surface shapes 131 to 133. The prediction unit 105 stores the calculated prediction model 145 in the storage unit 101.

As described above, the prediction unit 105 calculates the prediction model 145 by using the detection result 113 that is the shape of the manufactured portion 13a which is detected by the measurement device 26, the CAD data 111, the sample shape DB 114, and the finish error model DB 115. Note that the prediction unit 105 can calculate the prediction model 145 by the other methods without limitation to the method. For example, the prediction unit 105 may calculate a tendency of a shape error of the manufactured portion 13a from the plurality of detection results 113, and may calculate the prediction model 145 by using the tendency of the shape error.

Next, the evaluation unit 106 determines whether or not the prediction model 145 is in a permissible range (S210). The evaluation unit 106 set a shape error permissible range 147 of the manufactured object 13. The shape error permissible range 147 is an example of a threshold. FIG. 12 schematically illustrates the shape error permissible range 147 with a one-dot chain line.

The shape error permissible range 147 is, for example, dimensional tolerance data, which is included in the CAD data 111, of the manufactured object 13. The shape error permissible range 147 is not limited thereto. For example, the evaluation unit 106 can set a range of ±1 mm from the three-dimensional shape of the manufactured object 13 in the CAD data 111 as the shape error permissible range 147.

The evaluation unit 106 acquires data of the prediction model 145 from the storage unit 101. The evaluation unit 106 compares the prediction model 145 and the three-dimensional shape data in the CAD data 111 with each other. The evaluation unit 106 determines whether or not the prediction model 145 exceeds a shape range defined by the shape error permissible range 147.

The evaluation unit 106 determines whether or not respective coordinates of the prediction model 145 are in the shape range defined by the shape error permissible range 147. FIG. 13 is a graph illustrating an example of a residual of the detected shape 140 and the prediction model 145. In FIG. 13, the vertical axis represents a residual from the CAD data 111 of the manufactured portion 13a. The horizontal axis represents a number of a layer that is formed.

In the graph in FIG. 13, a residual from the CAD data 111 of the manufactured portion 13a (detected shape 140) that is already manufactured is indicated by a solid line, and a residual from the CAD data 111 of the prediction model 145 is indicated by a two-dot chain line. The shape error permissible range 147 is set with focus to the CAD data 111.

As illustrated in FIG. 13, in a case where the prediction model 145 exceeds the shape error permissible range 147, the evaluation unit 106 determines that the prediction model 145 is out of the shape range defined by the shape error permissible range 147 (No in S210). In a case where, the prediction model 145 is on an inner side of the shape error permissible range 147, the evaluation unit 106 determines that the prediction model 145 is in the shape range defined by the shape error permissible range 147 (Yes in S210).

When the evaluation unit 106 makes the determination in the respective coordinates of the prediction model 145, the number of determination results increases. Accordingly, the evaluation unit 106 may determine whether or not the prediction model 145 is in the permissible range by using a multivariate SPC instead of making the determination in the respective coordinates of the prediction model 145.

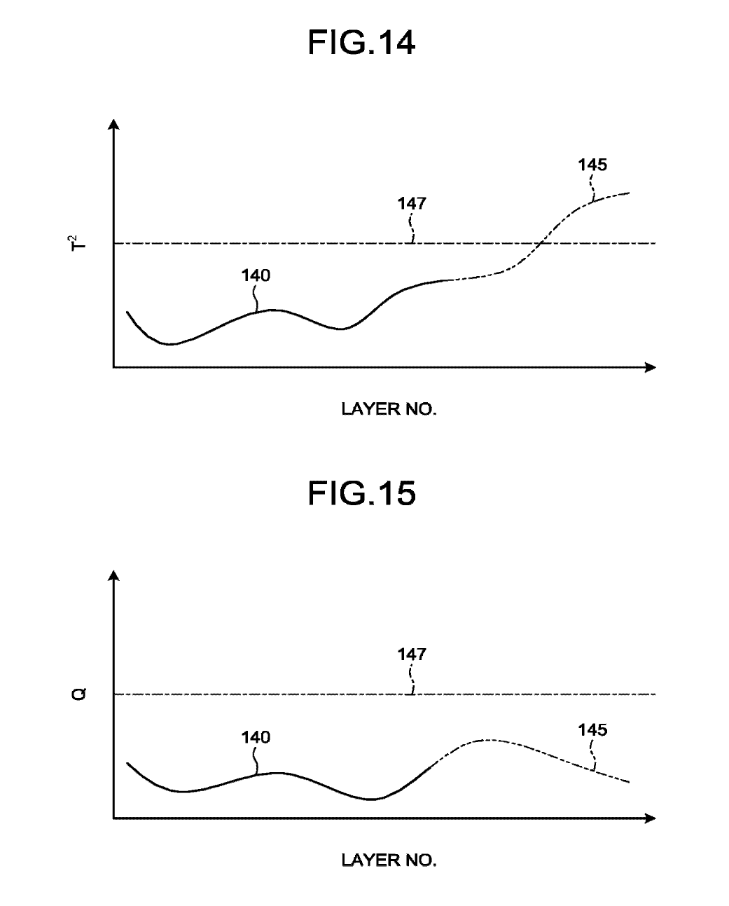

FIG. 14 is a graph illustrating an example of a T² statistic of the detected shape 140 and the prediction model 145. FIG. 15 is a graph illustrating an example of a Q statistic of the detected shape 140 and the prediction model 145. As illustrated in FIG. 14 and FIG. 15, at least one of the T² statistic and the Q statistic of the prediction model 145 exceeds the shape error permissible range 147, the evaluation unit 106 determines that the prediction model 145 is out of the shape range defined by the shape error permissible range 147 (No in S210). In a case where at least one of the T² statistic and the Q statistic of the prediction model 145 is on an inner side of the shape error permissible range 147, the evaluation unit 106 determines that the prediction model 145 is in the shape range defined by the shape error permissible range 147 (Yes in S210).

The evaluation unit 106 can suppress the number of determination results to two by making the determination by using the multivariate SPC. In a case where at least one of the T² statistic and the Q statistic of the prediction model 145 exceeds the shape error permissible range 147, it is possible to determine a portion, which exceeds the shape error permissible range 147, of the prediction model 145 through drill-down analysis.

As illustrated in FIG. 9, when it is determined that the prediction model 145 is out of the shape range defined by the shape error permissible range 147 (No in S210), the evaluation unit 106 stops the subsequent additive manufacturing, and issues an alarm (S211). In other words, in a case where a result of comparison between the prediction model 145 and the CAD data 111 exceeds the shape error permissible range 147, the evaluation unit 106 stops formation of the manufactured portion 13a with the optical device 25.

When the additive manufacturing is stopped, for example, a user of the three-dimensional printer 10 can change setting of the three-dimensional printer 10 to obtain the manufactured object 13 with relatively high accuracy in accordance with a corresponding alarm. In addition, the processing control unit 107 may evaporate a part of the manufactured portion 13a with the laser light L from the optical device 25, or may cut a part of the manufactured portion 13a through milling to correct the shape of the manufactured portion 13a. In addition, the three-dimensional printer 10 may cut out at least one layer 12 and may perform the additive manufacturing again.

When it is determined that the prediction model 145 is in the shape range defined by the shape error permissible range 147 (Yes in S210), the evaluation unit 106 determines whether or not repairing of the manufactured portion 13a is necessary (S212).

For example, in a case where a shape error between the prediction model 145 and the CAD data 111 exceeds a predetermined threshold (Yes in S212), the evaluation unit 106 determines that repairing is necessary for the manufactured portion 13a. In this case, the processing control unit 107 repairs the manufactured portion 13a (S213). The processing control unit 107 corrects the shape of the manufactured portion 13a on the basis of, for example, the shape error that is calculated.

For example, the processing control unit 107 controls the optical device 25 to cut out a part of the manufactured portion 13a with the laser light L from the optical device 25. In addition, the processing control unit 107 may bind a part of the powdered material 11 of the layer 12 with the laser light L from the optical device 25 so as to apply a new portion to the manufactured portion 13a. In this manner, the processing control unit 107 causes the optical device 25 to change the shape of the manufactured portion 13a by using the result of comparison between the prediction model 145 based on the detection result 113 and the CAD data 111.

In addition, in a case where the defect D, which exceeds a permissible range, occurs in the manufactured portion 13a, the processing control unit 107 repairs the manufactured portion 13a. For example, the processing control unit 107 controls the optical device 25 to melt again the portion, in which the defect D occurs, of the manufactured portion 13a with the laser light L from the optical device 25, thereby removing the defect D.

Next, the evaluation unit 106 determines whether or not it is necessary to correct various pieces of data such as the layer data 112 (S214). Even in a case where it is determined that repairing of the manufactured portion 13a is not necessary (No in S212), the evaluation unit 106 determines whether or not the correction of the data is necessary (S214).

For example, in a case where the shape error between the prediction model 145 and the CAD data 111 exceeds a predetermined threshold (Yes in S214), the evaluation unit 106 determines that correction of the data is necessary. In this case, for example, the evaluation unit 106 corrects the layer data 112 of an upper layer in comparison to the layer 12 in which the manufactured portion 13a is formed (S215).

For example, the evaluation unit 106 shifts a portion, in which the manufactured portion 13a is formed, of the layer data 112 of the upper layer on the basis of the shape error between the layer data 112 and the detection result 113. The binding control unit 103 binds a part of the subsequent layer 12 on the basis of the corrected layer data 112 to form the manufactured portion 13a. The data correction is not limited thereto.

next, the lamination control unit 102 determines whether or not formation of the entirety of layers 12 is completed (S216). Even in a case where it is determined that the data correction is not necessary (No in S214), the lamination control unit 102 determines whether or not formation of the entirety of layers 12 is completed (S216).

In a case where it is determined that formation of the entirety of layers 12 is not completed (No in S216), the lamination control unit 102 causes the material tank 23 and the supply device 24 to form the layer 12 of the material 11 again (S205). The three-dimensional printer 10 manufactures the manufactured object 13 by repeating formation of the layer 12, formation of the manufactured portion 13a, and evaluation of the manufactured portion 13a (S205 to S216). In a case where formation of the entirety of layers 12 is completed (Yes in S216), the three-dimensional printer 10 terminates the additive manufacturing of the manufactured object 13.

The manufactured object 13 that is manufactured is extracted from the powdered material 11, and is detached from the base plate 14. A user of the three-dimensional printer 10 can extract the manufactured object 13 from the treatment chamber 21a of the treatment tank 21.

As described above, the measurement device 26 detects the shape of the manufactured portion 13a which is formed in the layer 12. It is possible to determine that the shape error of the manufactured object 13 occurs in which process from a plurality of the detection results 113. A user of the three-dimensional printer 10 can correct various pieces of data from the detection results 113 to realize the additive manufacturing with relatively high accuracy. In addition, the control unit 27 can automatically correct various pieces of data to realize the additive manufacturing with relatively high accuracy.

For example, in a case where the shape error occurs whenever the optical device 25 forms the manufactured portion 13a, the evaluation unit 106 can change setting data of the optical device 25. In addition, in a case where the shape of the manufactured portion 13a in a lower layer varies during proceeding of the additive manufacturing, the evaluation unit 106 can correct the layer data 112 on the basis of an effect by the shape variation.

In addition, the shape error may occur in the manufactured object 13 due to stress release when the manufactured object 13 is detached from the base plate 14. In this case, the binding control unit 103 can generate the layer data 112 from the CAD data 111 in consideration of deformation due to the stress release.

As described above, the control unit 27 compares the shape of the manufactured portion 13a which is detected by the measurement device 26 and the CAD data 111. The control unit 27 causes the optical device 25 to form the manufactured portion 13a by using the result of comparison. For example, the control unit 27 can repair the manufactured portion 13a whenever the shape of the manufactured portion 13a and the layer data 112 are different from each other without limitation to the method.

In the three-dimensional printer 10 according to the first embodiment, the measurement device 26 detects the shape of the manufactured portion 13a that is formed in at least one layer 12 including the layer 12 that forms the surface 12a of the plurality of layers 12. The layer 12 that forms the surface 12a of the plurality of layers 12 is at least partially bound with the optical device 25, and thus the layer 12 is exposed without being covered with the peripheral wall 36 or the powdered material 11. Accordingly, the measurement device 26 can easily detect the shape of the manufactured portion 13a that is formed in at least one layer 12 including the layer 12 in which the surface 12a of the plurality of layers 12 is formed. Since three-dimensional printer 10 can use the detection result 113 of the shape of the manufactured portion 13a, the three-dimensional printer 10 can perform the additive manufacturing with relatively high accuracy.

The control unit 27 at least indirectly compares the shape of the manufactured portion 13a which is detected by the measurement device 26, and the CAD data 111. Since the three-dimensional printer 10 can use the result of comparison between the shape of the manufactured portion 13a which is detected by the measurement device 26 and the CAD data 111, the three-dimensional printer 10 can perform the additive manufacturing with relatively high accuracy.

The control unit 27 causes the optical device 25 to bind at least a part of the layer 12 that forms the surface 12a of the plurality of layers 12 by using the at least indirect result of comparison between the shape of the manufactured portion 13a which is detected by the measurement device 26 and the CAD data 111. That is, the control unit 27 feeds back the result of comparison, and causes the optical device 25 to bind at least a part of the layer 12. According to this, an error in formation of the manufactured portion 13a with the optical device 25 is corrected during binding of the subsequent layer 12, and thus the three-dimensional printer 10 can perform the additive manufacturing with relatively high accuracy.

The control unit 27 causes the optical device 25 to change the shape of the manufactured portion 13a which is formed in the layer 12 that forms the surface 12a of the plurality of layers 12 by using the at least indirect result of comparison between the shape of the manufactured portion 13a which is detected by the measurement device 26 and the CAD data 111. According to this, the error in formation of the manufactured portion 13a with the optical device 25 is corrected immediately after the binding, and thus the three-dimensional printer 10 can perform the additive manufacturing with relatively high accuracy.

The control unit 27 calculates the prediction model 145 of the manufactured object 13 which is formed on the basis of the shape of the manufactured portion 13a which is detected by the measurement device 26, and at least indirectly compares the prediction model 145 and the CAD data 111. That is, the control unit 27 can detect a possibility in that an error occurs in formation of the manufactured portion 13a with the optical device 25 in advance. Since the three-dimensional printer 10 can use the at least indirect result of comparison between the prediction model 145 and the CAD data 111, the three-dimensional printer 10 can perform the additive manufacturing with relatively high accuracy.

The control unit 27 calculates the prediction model 145 by using the shape of the manufactured portion 13a which is detected by the measurement device 26, the CAD data 111, the sample shape DB 114, and the finish error model DB 115. According to this, the control unit 27 can calculate the prediction model 145 on which the error in the formation of the manufactured portion 13a with the optical device 25 reflects, and the three-dimensional printer 10 can perform the additive manufacturing with relatively high accuracy.

In a case where the at least indirect result of comparison between the prediction model 145 and the CAD data 111 exceeds the shape error permissible range 147, the control unit 27 stops manufacturing of the manufactured portion 13a with the optical device 25. According to this, additive manufacturing of the manufactured object 13 with low accuracy is suppressed, and thus the three-dimensional printer 10 can perform the additive manufacturing with high accuracy.

The measurement device 26 irradiates the layer 12 that forms the surface 12a of the plurality of layers 12 with the X-ray beam B, and detects the shape of the manufactured portion 13a, which is formed in at least one layer 12 including the layer 12 that forms the surface 12a of the plurality of layers 12, with the X-ray beam B. According to this, the measurement device 26 can detect the shape of the manufactured portion 13a, which is formed in at least one layer 12 including the layer 12 that forms the surface 12a of the plurality of layers 12, with the X-ray beam B with low energy. In addition, the measurement device 26 can detect the defect D that occurs at the inside of the manufactured portion 13a.

The measurement device 26 detects the shape of the manufactured portion 13a that is formed in at least one layer 12 including the layer 12 that forms the surface 12a of the plurality of layers 12 on the basis of the angle between the surface 12a of the plurality of layers 12 and the X-rays S which are diffracted by the at least one layer 12 including the layer 12 that forms the surface 12a of the plurality of layers 12. The intensity of the diffracted X-rays S is distributed to be the maximum at a predetermined angle θ. However, in a case where the defect D exists at the inside of the manufactured portion 13a, the distribution of the intensity of the diffracted X-rays S becomes relatively gentle. According to this, the measurement device 26 can detect the defect D, which occurs at the inside of the manufactured portion 13a, in a more apparent manner.

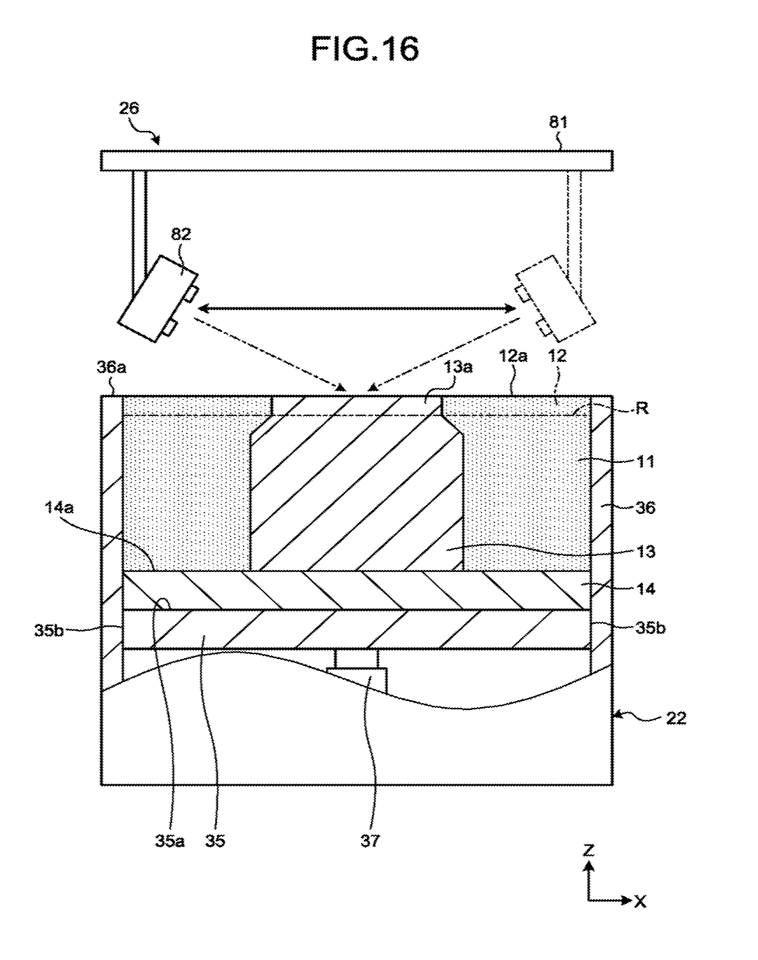

Hereinafter, description will be given of a second embodiment with reference to FIG. 16. Furthermore, in the following description of the embodiment, the same reference numeral will be given of a constituent element having the same function as a constituent element that has been described already, and description thereof may be omitted. In addition, a plurality of constituent elements, to which the same reference numeral is given, are not limited to have functions and properties which are common, and may have other functions and properties which are different in accordance with respective embodiments.

FIG. 16 is a cross-sectional view illustrating a measurement device 26 and a manufacturing tank 22 according to the second embodiment. As illustrated in FIG. 16, the measurement device 26 of the second embodiment includes a movement unit 81 and an optical device 82.

The movement unit 81 is disposed on an upward side of the manufacturing tank 22. The movement unit 81 can rotate the optical device 82 around a central axis that is approximately perpendicular to the surface 12a of the layer 12. The movement unit 81 is not limited thereto.

The optical device 82 is, for example, a laser scanner. The optical device 82 is not limited thereto. For example, the optical device 82 may be other optical device such as a 3D camera capable of detecting a three-dimensional shape. The optical device 82 detects a three-dimensional shape of the manufactured portion 13a which is formed in the layer 12 that forms the surface 12a of the plurality of layers 12.

Furthermore, the optical device 82 may be other monocular optical devices such as a CCD camera. The monocular optical device 82 detects the shape of the manufactured portion 13a which is formed in the layer 12 by capturing an image of the surface 12a of the plurality of layers 12.

In the three-dimensional printer 10 of the second embodiment, the measurement device 26 includes the optical device 82 that detects the shape of the manufactured portion 13a which is formed in the layer 12 that forms the surface 12a of the plurality of layers 12. According to this, the measurement device 26 can detects the shape of the manufactured portion 13a without using an X-ray protection material and the like.

The optical device 82 detects the three-dimensional shape of the manufactured portion 13a which is formed in the layer 12 that forms the surface 12a of the plurality of layers 12. According to this, for example, the surface height of the manufactured portion 13a is detected, and the shape of the manufactured portion 13a can be corrected on the basis of the surface height.

According to at least one of the above-described embodiments, the detection unit detects the shape of a part of the manufactured object that is formed in one or more layers including the layer that forms the surface of the plurality of layers. According to this, the additive manufacturing apparatus can perform additive manufacturing with relatively high accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1: An additive manufacturing apparatus, comprising:
a laminate formation unit configured to form a plurality of laminated layers of a powdered material;
a binding formation unit configured to bind at least a part of a layer to form a part of a manufactured object, the layer forming a surface of the plurality of layers;
a control unit configured to cause the binding formation unit to bind at least a part of the layer forming the surface of the plurality of layers on the basis of shape information of the manufactured object; and
a detection unit configured to detect a shape of the part of the manufactured object, the part of the manufactured object formed in at least one layer including the layer forming the surface of the plurality of layers,
wherein the control unit is configured to compare the shape of the part of the manufactured object, which is detected by the detection unit, and the shape information of the manufactured object.

2: An additive manufacturing apparatus, comprising:
a laminate formation unit configured to form a plurality of laminated layers of a powdered material;
a binding formation unit configured to bind at least a part of a layer to form a part of a manufactured object, the layer forming a surface of the plurality of layers;
a detection unit configured to detect a shape of the part of the manufactured object, the part of the manufactured object formed in at least one layer including the layer forming the surface of the plurality of layers; and
a control unit configured to control the binding formation unit on the basis of the shape of the part of the manufactured object detected by detection unit.

3: The additive manufacturing apparatus according to claim 1, wherein the control unit is configured to cause the binding formation unit to bind at least a part of the layer forming the surface of the plurality of layers by using a result of comparison between the shape of the part of the manufactured object, which is detected by the detection unit, and the shape information of the manufactured object.

4: The additive manufacturing apparatus according to claim 1, further comprising:
a processing unit configured to change the shape of the part of the manufactured object formed in the layer forming the surface of the plurality of layers,
wherein the control unit is configured to cause the processing unit to change the shape of the part of the manufactured object formed in the layer forming the surface of the plurality of layers by using the result of comparison between the shape of the part of the manufactured object, which is detected by the detection unit, and the shape information of the manufactured object.

5: The additive manufacturing apparatus according to claim 1, wherein the control unit is configured to calculate a predicted shape of the manufactured object, that is formed, on the basis of the shape of the part of the manufactured object which is detected by the detection unit, and is configured to compare the predicted shape and the shape information of the manufactured object.

6: The additive manufacturing apparatus according to claim 5, wherein
the control unit is configured to calculate the predicted shape by using the shape of the part of the manufactured object which is detected by the detection unit, the shape information of the manufactured object, the shape information of the plurality of samples, and the error prediction information calculated from shapes of the plurality of samples formed in advance by the binding formation unit.

7: The additive manufacturing apparatus according to claim 6, wherein
in a case where the result of comparison between the predicted shape and the shape information of the manufactured object exceeds a range of a threshold, the control unit is configured to stop the binding formation unit.

8: The additive manufacturing apparatus according to claim 1, wherein the detection unit is configured to irradiate the surface of the plurality of layers with an X-ray, and to detect the shape of the part of the manufactured object, which is formed in the at least one layer including the layer forming the surface of the plurality of layers, by using the X-ray.

9: The additive manufacturing apparatus according to claim 8, wherein the detection unit is configured to detect the shape of the part of the manufactured object formed in the at least one layer including the layer forming the surface of the plurality of layers on the basis of an angle between the surface of the plurality of layers and the X-ray diffracted by the at least one layer including the layer forming the surface of the plurality of layers.

10: The additive manufacturing apparatus according to claim 1,
wherein the detection unit includes an optical device configured to detect the shape of the part of the manufactured object formed in the layer forming the surface of the plurality of layers.

11: The additive manufacturing apparatus according to claim 10, wherein the optical device is configured to detect a three-dimensional shape of the part of the manufactured object formed in the layer forming the surface of the plurality of layers.

12: An additive manufacturing method, comprising:
comparing a detection result of a manufactured object formed in a part of a layer of a powdered material and shape information of the manufactured object; and
controlling manufacture of the manufactured object on the basis of a result of comparison.
